(19) United States
(12) Patent Application Publication
(10) Pub. No.: US 2017/0013622 A1
(43) Pub. Date: Jan. 12, 2017

(54) CARRIER SWAPPING FOR LTE-U (LTE-UNLICENSED SPECTRUM) METHOD AND APPARATUS

(71) Applicant: ZTE CORPORATION, Guangdong, Shenzhen (CN)

(72) Inventor: Carolyn TAYLOR, Homewood, IL (US)

(21) Appl. No.: 15/113,673

(22) PCT Filed: Jan. 20, 2015
(86) PCT No.: PCT/IB2015/000566

§ 371 Date: Jul. 22, 2016

Related U.S. Application Data
(60) Provisional application No. 61/930,108, filed on Jan. 22, 2014.

(51) Int. Cl. H04W 72/04; H04W 24/10; H04W 16/14; H04B 17/318

(52) U.S. Cl. CPC H04W 72/0453; H04B 17/318; H04W 24/10; H04W 16/14; H04W 72/0486

(57) ABSTRACT

A wireless communication system includes a plurality of communication devices. The RF transceiver includes a transmitter and a plurality of receivers, each receiving signal from an associated communication device. A Enhanced Node B (eNB) can communicate with a plurality of communication devices in a Multiple-Input Multiple-Output (MIMO) system. The Node B includes a transmitter and plurality of antenna configured to transmit control information. The wireless communication system may utilize licensed and unlicensed RF spectrum. Long Term Evolution (LTE) is transmitted according to licensed and unlicensed spectrum. The invention deals with swapping between primary carrier and secondary carrier(s) for licensed and unlicensed spectrum.

### BACKGROUND OF THE INVENTION

Wireless communications is continuously evolving. There are many types of advanced technology equipment being introduced that can provide services that were not possible previously. This advanced technology equipment might include, for example, an Enhanced Node B (eNB) rather than a base station or other systems and devices that are more highly evolved than the equivalent equipment in a traditional wireless telecommunications system. Such advanced or next generation equipment may be referred to herein as High Speed Packet Access (HSPA) equipment, long-term evolution (LTE) equipment and long-term evolution (LTE) Advanced equipment.

Devices with wireless communications capabilities, such as mobile telephones, handheld devices, devices embedded in laptop computers, Machine-2-Machine devices (M2M), and similar devices, will be referred to herein as User Equipment (UE).

In traditional wireless telecommunications systems, transmission equipment in a base station transmits signals throughout a geographic region and is called a “cell”. For LTE and other advanced equipment, the region in which a UE can gain access to a wireless communications network might be referred to as a different name, for instance called a “hot spot”. The terminology, for example “cell”, will be used herein to refer to any geographic region in which a UE can gain access to a wireless communications network, regardless of the type of UE and regardless of whether the region is a traditional cell, a region served by LTE equipment such as an eNB, or some other region in which wireless communications services are available.

Heterogeneous networks (HetNets) consist of a mix of macrocells, remote radio heads, and low-power nodes such as picocells, femtocells, and relays. A HetNet is a network consisting of infrastructure points with various wireless access technologies, each of them having different capabilities, constraints, and operating functionalities.

Leveraging network topology, increasing the proximity between the access network and the end-users, has the potential to provide the next significant performance leap in wireless networks, improving spatial spectrum reuse and enhancing indoor coverage.

Different UEs might use different types of radio access technology (RAT) to access a wireless communications network. Some UEs, which can be referred to as multi-mode UEs, are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems.

LTE has rapidly been adopted in different regions of the world which shows both that demand for wireless broadband data is increasing and that LTE can be utilized to meet that demand. The massive growth in data traffic carried by mobile broadband (MBB) systems put severe pressure on the LTE wireless communication system. In order to meet the MBB traffic demand, the industry must evolve the wireless communication system with great capacity increase.

Unlicensed spectrum need to be a potential method to use to offload the traffic from the licensed carriers.

Wireless communication system to continuously evolve with both licensed and unlicensed spectrum.

LTE advanced technology evolving with unlicensed spectrum integrated into and controlled by the licensed carriers for high efficiency, easy deployment and operation.

There are two types of spectrum in use: licensed spectrum which is used for specific applications using specific technologies by the spectrum owner and unlicensed spectrum which is shared by many technologies.

Unlicensed spectrum technology is currently used around the world by a multitude of devices accessing the spectrum using communication protocols that include spread spectrum, frequency hopping, listen before talk and collision avoidance.

Licensed spectrum technologies, such as 3GPP LTE and LTE Advanced do not assume that spectrum is shared and consequently do not employ any politeness aspects in their channel access mechanisms.

Licensed and unlicensed spectrum technologies are currently used by consumers to access the internet and other services without interference by working on different spectrum bands.

The shared spectrum must be based on an air interface that improve authentication and security management, service quality guarantee, OSS and radio resource management.

Unlicensed spectrum can be utilized as a complement to licensed deployments which brings great value to LTE wireless communication system.

Extending the LTE wireless communication system to integrate unlicensed deployments would enable operators and vendors to maximally leverage existing or planned wireless communication systems.

The possible Rel-13 study item would be required to determine which enhancements to LTE are needed to enable its deployment in unlicensed spectrum in coexistence with other technologies and fulfilling the regulatory requirements.

### BRIEF SUMMARY OF THE INVENTION

An object of the invention is to provide a method swapping between primary carrier and secondary carrier(s) for licensed and unlicensed spectrum. Multiple carriers (using LTE licensed and unlicensed spectrum) to be used together to provide higher data rates.

In one aspect of the invention is provided a wireless communication method in a UE. The wireless communication method comprises measuring a network signal strength, sending a measurement report, and receiving a report to inform a serving cell of an interference capability of the UE and of measurements of signals received by the UE from the serving cell and a neighbor cell.

In another aspect of the invention is provided a method of measuring interference capability. The method of measuring interference capability comprises transmitting a measurement for load capabilities and DL measurements, receiving a request to report load capabilities and a measurement parameter, determining the measurement parameter and generating and transmitting a report in which the load capabilities and the measurement parameter are reported.

Yet another aspect of the invention provides a wireless communication system comprising a primary carrier capable of controlling signaling, mobility, and user data, as well as a secondary carrier capable of providing best effort user data in downlink. A licensed and an unlicensed carrier between the primary carrier and the secondary carrier can be swapped for a UE.

Another aspect of the invention provides a wireless communication system comprising a multi-mode UE, a primary component carrier, and a secondary component. The multi-mode UE has a processor configured to promote measurements of a signal strength in the wireless communication system and runs an application that increasingly demands higher data rates. The primary component carrier is a main carrier and is one of a licensed carrier and an unlicensed carrier. The secondary component is a secondary carrier and is one of a licensed carrier and an unlicensed carrier. The multi-mode UE determines the primary component carrier according to loading on the carriers. The multi-mode UE swaps between a licensed carrier and an unlicensed carrier.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a wireless communications system according to an embodiment of the disclosure.

FIG. 2 is a diagram of a data transmission according to an embodiment of the disclosure.

FIG. 3 is a diagram of a method for measuring signal strength according to an embodiment of the disclosure.

FIG. 4 is a diagram of a wireless communications system including a user equipment and serving cell operable for some of the various embodiments of the disclosure.

FIG. 5 is a diagram of a diagram of a wireless communications system that illustrates the configuration of a primary carrier and secondary carrier(s) for licensed and unlicensed spectrum swapping.

### DETAILED DESCRIPTION OF THE INVENTION

The present inventions now will be described more fully hereinafter with reference to the accompanying drawings, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical adaptive data transmission system and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art. Indeed, these disclosure inventions may be embodied in many different forms and should not be construed as limited to the embodiments set forth therein; rather, these embodiments are provided by way of example so that this disclosure will satisfy applicable legal requirements. Like numbers refer to like elements throughout.

In one aspect of the invention is provided a wireless communication method in a UE. The wireless communication method comprises measuring a network signal strength, sending a measurement report, and receiving a report to inform a serving cell of an interference capability of the UE and of measurements of signals received by the UE from the serving cell and a neighbor cell. Any number of UE can be used. UE includes any device that is used directly by an end-user to communicate and can include any number of devices, for example a hand-held telephone, cellular telephone, laptop computer equipped with a mobile broadband adapter, a television equipped with a mobile broadband adapter, a keyboard, a smartphone, or a Bluetooth-equipped headset.

The UE may be a multi-mode UE. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is included herein by reference for all purposes. Some examples of RATs or of network technologies that might use different types of RATs include UTRAN (UTMS Terrestrial Radio Access Network), GSM, GSM EDGE Radio Access Network (GERAN), Wireless Fidelity (WiFi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

It is appreciated that there are a number of ways of measuring network signal strength. In general, the signal strength is expressed as voltage per length or the actual power of the signal received by a reference antenna. The power of the signal can be calculated if the power delivered to the transmitting antenna as well as the electric field geometry and radiation resistance are known.

In some embodiments, the network signal strength is a network pilot signal strength.

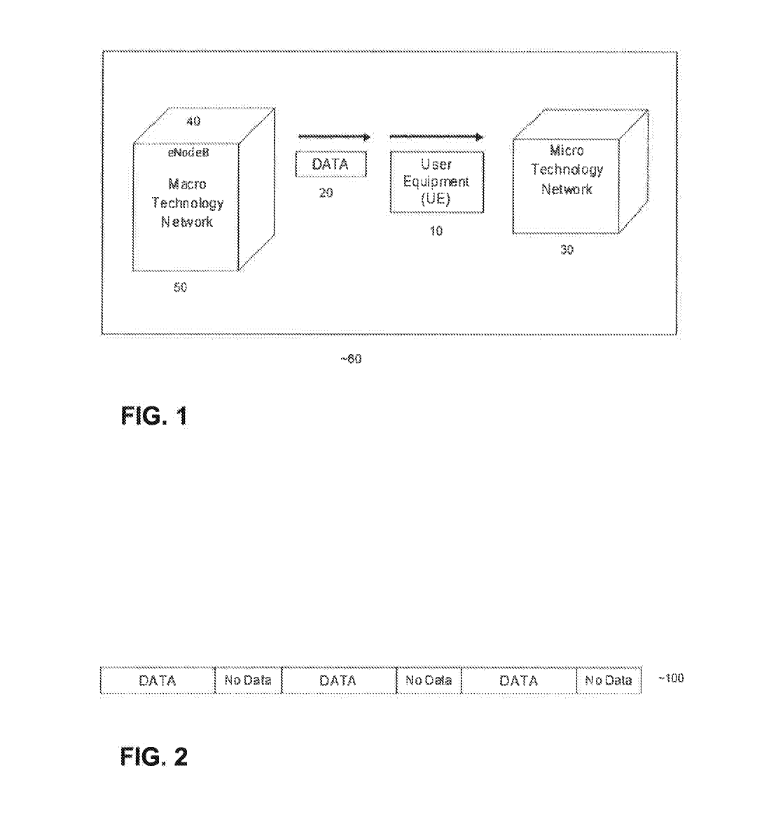

FIG. 1 illustrates a situation in which such a measurement might occur. A UE is moving from a macro technology network toward a micro technology network. The macro technology network includes an eNB, or a similar component. The UE may be engaged in a macro technology running an application via the eNB. That is, the eNB is transmitting data to the UE or is otherwise in communication with the UE.

In some embodiments, the measuring is periodic. The measuring can also occur when no data is transmitted. FIG. 2 illustrates a detailed view of the data transmission from the eNB to the UE. The data transmission consists of a series data strings separated by a transmission period in which no data and data is transmitted. The data strings might represent some type of a user-directed data transmission. During the period which no data is transmitted, the UE can measure the strengths of the signals that it receives. In a first technique, a method for measuring signal strength is provided. The method includes the multi-mode LIE being measured. In an alternative of this technique, a method for measuring signal strength is provided. The method includes periodic measurements to track and monitor traffic load performance.

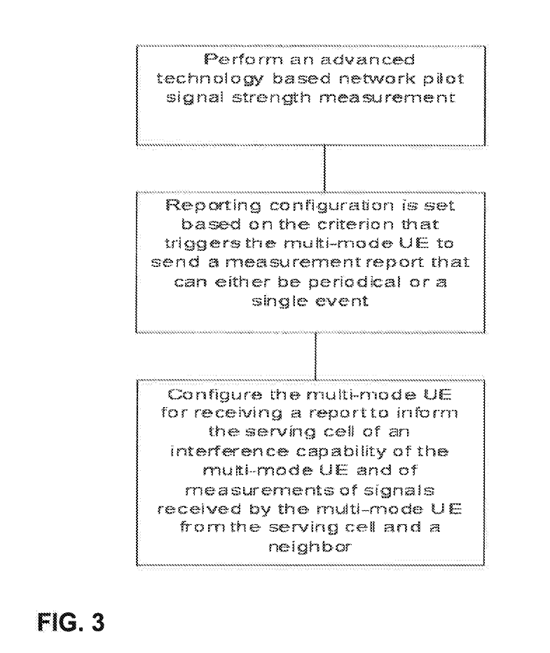

In some embodiments, the UE is a multi-mode UE. The multi-mode UE includes a processor configured to promote measurements of a signal strength in a communication system miming an application that increasingly demands higher data rates. FIG. 3 illustrates an embodiment of a method for measuring the strength of the multi-mode UE of UE according to the loading on the various carriers' capability. The UE sends a measurement reporting.

A measurement report can be in a variety of formats. The measurement report can include the measured power level of the signal. In addition, the power levels of neighboring cells and other signals can be included in the measurement report.

In some embodiments, the aspect can further comprise setting a reporting configuration based on a condition, wherein the condition triggers the sending of the measurement report. For example, the condition may be that the signal strength is below a certain threshold.

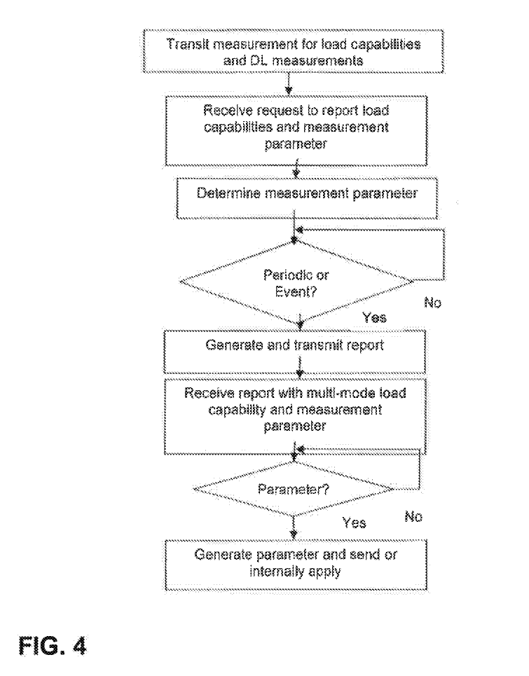

FIG. 4 is a flowchart that illustrates methods of operating a serving cell and a multi-mode UE for a wireless communications system. The serving cell transmits at least one message to at least one multi-mode UE within its cell that the UEs should inform the cell of the capability of the respective UEs and their DL signal measurements, e.g., the RSRP of the serving cell and RSRPs of candidate neighbor cells, which can be macro cells and/or micro/pico/femto cells. The at least one message includes a parameter value for use by a multi-mode UE in determining its parameter according to the loading on the various carriers.

In another aspect of the invention is provided a method of measuring interference capability. The method of measuring interference capability comprises transmitting a measurement for load capabilities and DL measurements, receiving a request to report load capabilities and a measurement parameter, determining the measurement parameter and generating and transmitting a report. Load capabilities and the measurement parameter are reported.

In some embodiments, the method is conducted in a periodic manner. In some embodiments, the method is periodic.

In some embodiments, the method further comprises a step of receiving the report.

In some embodiments, the method further comprises generating and sending the parameter.

In some embodiments, the method further comprises generating and internally applying the parameter.

In yet another aspect of the invention is provided a wireless communication system comprising a primary carrier and a secondary carrier. The primary carrier is capable of controlling signaling, mobility, and user data. The secondary carrier is capable of providing best effort user data in downlink. A licensed and an unlicensed carrier between the primary carrier and the secondary carrier can be swapped for a UE.

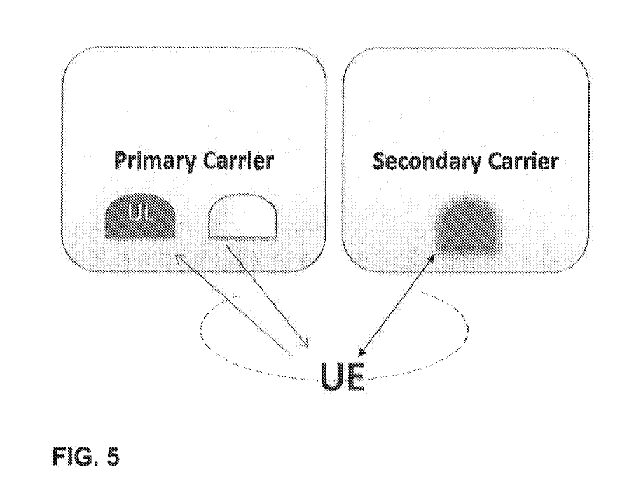

FIG. 5 illustrates an embodiment of a method for primary carrier and secondary carrier(s) in a wireless communication system in which the licensed and unlicensed carrier between the primary carrier and secondary carrier(s) can be swapped. The primary carrier is capable of controlling signaling, mobility, and user data. The secondary carrier(s) provides best effort user data in downlink.

In a further aspect of the invention is provided a wireless communication system comprising a multi-mode UE, a primary component carrier and a secondary component. The multi-mode UE has a processor configured to promote measurements of a signal strength in the wireless communication system and run an application that increasingly demands higher data rates. The primary component carrier is a main carrier and is one of a licensed carrier and an unlicensed carrier. The secondary component is a secondary carrier and is one of a licensed carrier and an unlicensed carrier. The multi-mode UE determines the primary component carrier according to loading on the carriers and the multi-mode UE swaps between a licensed carrier and an unlicensed carrier.

In some embodiments, the primary component carrier is configured to be UE-specific and determined according to loading on the carriers. The primary component carrier may have a lesser loading than the secondary component carrier.

In some embodiments, the wireless communication system further comprises a transmitter for sending a periodic measurement to track and monitor traffic load performance.

In various embodiments of the above aspects, the LTE-U is considered to be a component carrier in a LTE Carrier Aggregation configuration.

in various embodiments of the above aspects, there are two categories of component carriers in a LTE Carrier Aggregation configuration.

In a further aspect is provided a method that configure the primary component carrier as licensed or unlicensed carrier. The primary component carrier is the main carrier in any group. There will be a primary downlink carrier and an associated uplink primary component carrier.

In yet another aspect is a method that configures the secondary component carrier(s) as licensed or unlicensed carrier(s). The secondary component carrier may be one or more secondary component carriers.

In various embodiments of the above aspects, the LTE-U is always accompanied by a licensed carrier.

In various embodiments of the above aspects, the configuration of the primary component carrier is UE specific and will be determined according to the loading on the various carriers as well as other relevant parameters. The information is signaled to the UE as part of the overall signaling between the UE and the eNB.

Another aspect of the invention is a method that instructs a multi-mode UE to determine the primary component carrier according to the loading on the various carriers as well as other relevant parameters.

In various embodiments of the above methods is included a transmitter configured for sending, a periodic measurement to track and monitor traffic load performance.

Another aspect of the invention is a method to swap licensed and unlicensed spectrum.

Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims.

What is claimed is:

1. A wireless communication method in a UE comprising:
measuring a network signal strength;
sending a measurement report; and
receiving a report to inform a serving cell of an interference capability of the UE and of measurements of signals received by the UE from the serving cell and a neighbor cell.

2. The method of claim 1, wherein the measuring is periodic.

3. The method of claim 1, further comprising setting a reporting configuration based on a condition, wherein the condition triggers the sending.

4. The method of claim 1, wherein the measuring occurs when no data is transmitted.

5. The method of claim 1, wherein the network signal strength is a network pilot signal strength.

6. The method of claim 1, wherein the UE is a multi-mode UE.

7. A method of measuring interference capability comprising:
transmitting a measurement for load capabilities and DL measurements;
receiving a request to report load capabilities and a measurement parameter;
determining the measurement parameter; and
generating and transmitting a report, wherein load capabilities and the measurement parameter is reported.

8. The method of claim 7, wherein the method is periodic.

9. The method of claim 7, further comprising receiving the report.

10. The method of claim 9, further comprising generating and sending the parameter.

11. The method of claim 9, further comprising generating and internally applying the parameter.

12. A wireless communication system comprising:
a primary carrier capable of controlling signaling, mobility, and user data;
a secondary carrier capable of providing best effort user data in downlink;
wherein a licensed and an unlicensed carrier between the primary carrier and the secondary carrier can be swapped for a UE.

13. A wireless communication system comprising:
a multi-mode UE haying a processor configured to promote measurements of a signal strength in the wireless communication system and run an application that increasingly demands higher data rates;
a primary component carrier, wherein the primary component carrier is a main carrier and is one of a licensed carrier and an unlicensed carrier;
a secondary component, wherein the secondary component is a secondary carrier and is one of a licensed carrier and an unlicensed carrier;
wherein the multi-mode UE determines the primary component carrier according to loading on the carriers; and
wherein the multi-mode UE swaps between a licensed carrier and an unlicensed carrier.

14. The wireless communication system of claim 13, wherein the primary component carrier is configured to be UE-specific and determined according to loading on the carriers;

15. The wireless communication system of claim 13, further comprising a transmitter for sending a periodic measurement to track and monitor traffic load performance.
